(19) United States
(12) Patent Application Publication
(10) Pub. No.: US 2026/0124087 A1
(43) Pub. Date: May 7, 2026

(54) COLLAPSIBLE SIDERAIL FOR A PATIENT SUPPORT APPARATUS

(71) Applicant: UMANO MEDICAL INC., L'Islet (CA)

(72) Inventors: Christian GAUVIN, Levis (CA); Stephan DEMERS, Levis (CA); Jimmy LAFLAMME LAROCHE, Levis (CA); William TREMBLAY, Quebec (CA)

(73) Assignee: UMANO MEDICAL INC., L'Islet (CA)

(21) Appl. No.: 19/366,634

(22) Filed: Oct. 23, 2025

Related U.S. Application Data
(60) Provisional application No. 63/715,085, filed on Nov. 1, 2024.

(51) Int. Cl. A61G 7/05

(52) U.S. Cl. CPC A61G 7/0508; A61G 7/0519

(57) ABSTRACT

A siderail includes upper and lower siderail bodies, and a linkage assembly operatively connected thereto for guiding movement of the siderail between a deployed position and a stowed position. In the deployed position, the upper siderail body is disposed above the lower siderail body so that the siderail has a deployed height. In the stowed position, the lower siderail body is disposed at least partly laterally inwardly of the upper siderail body so that the siderail has a smaller stowed height. The linkage assembly includes: a first link pivotably connected to a frame connector; a second link pivotably connected to the first link; a third link pivotably connected to the second link and pivotably connected to the upper siderail body; and a fourth link pivotably connected to the frame connector and to the upper siderail body. The second and fourth links are ternary links that are connected to each other.

### CROSS-REFERENCE

The present patent application claims priority from U.S. Provisional Ser. No. 63/715,085 , filed Nov. 1, 2024, the entirety of which is incorporated by reference herein.

### TECHNICAL FIELD

The invention generally relates to a siderail for patient support apparatus. More particularly, it concerns a collapsible siderail.

### BACKGROUND

Hospital beds are typically provided with siderails on their lateral sides to prevent a patient from falling off the bed. Notably, siderails can be raised to a deployed position to block the patient's egress from bed and lowered to a stowed position to allow access into and out of the bed. However, in the stowed position, the siderail may block access to certain controls found at a base of the bed (e.g., controls operated by a user's foot) and may, in some beds, reduce a clearance between the bed and the floor.

In order to address this issue, some beds are provided with siderails that are foldable so that when the siderail is moved to the stowed position, the siderail is folded so that the height of the siderail is reduced in the stowed position. Nonetheless, in some cases, the height of the siderail may still be excessive in the stowed position and the siderail might extend too far outward from the bed as it moves from the deployed position to the stowed position, thus requiring more free space to each side of the bed in order to collapse the siderail.

There is therefore a need for a siderail that addresses at least in part some of these drawbacks.

### SUMMARY

In accordance with one aspect, there is provided a siderail for a patient support apparatus, comprising: an upper siderail body; a lower siderail body; a linkage assembly operatively connected to the upper and lower siderail bodies and configured to guide movement of the siderail between a deployed position and a stowed position, in the deployed position, the upper siderail body being disposed above the lower siderail body so that the siderail has a deployed height defined between an upper end of the upper siderail body and a lower end of the lower siderail body, in the stowed position, the lower siderail body being disposed at least partly laterally inwardly of the upper siderail body so that the siderail has a stowed height defined between the upper end of the upper siderail body and a lower end of the upper siderail body, the deployed height being greater than the stowed height, the linkage assembly comprising: a first link pivotably connected to a frame connector at a first frame joint; a second link pivotably connected to the first link at a first connecting joint; a third link pivotably connected to the second link at a second connecting joint disposed vertically higher than the first connecting joint and pivotably connected to the upper siderail body at a first body joint; and a fourth link pivotably connected to the frame connector at a second frame joint, the fourth link being pivotably connected to the upper siderail body at a second body joint, the second link and the fourth link being ternary links that are connected to each other at an intermediate joint, the intermediate joint being disposed, along the second link, between the first connecting joint and the second connecting joint, the intermediate joint being disposed, along the fourth link, between the second frame joint and the second body joint.

In some embodiments, the first body joint is disposed vertically higher than the second body joint.

In some embodiments, the second body joint is disposed generally along the lower end of the upper siderail body.

In some embodiments, in the stowed position, the first body joint is disposed vertically lower than the second connecting joint.

In some embodiments, in the stowed position, the first, second and third links overlap each other in a vertical direction.

In some embodiments, the first frame joint is disposed vertically lower than the second frame joint.

In some embodiments, in the stowed position, the second link extends generally parallel to the upper siderail body and is disposed laterally inwardly of the upper siderail body.

In some embodiments, the lower siderail body is pivotably connected to the upper siderail body.

In some embodiments, the second body joint is coaxial with a pivot defined between the lower siderail body and the upper siderail body.

In some embodiments, the fourth link includes a first arm and a second arm spaced from the first arm in a longitudinal direction of the siderail; and the second link is disposed longitudinally between the first and second arms.

In some embodiments, the lower siderail body includes a first lower siderail member and a second lower siderail member spaced from the first lower siderail member in a longitudinal direction of the siderail; and each of the first and second lower siderail members is connected to the second link so that movement of the first and second lower siderail members is guided by the second link.

In some embodiments, the lower siderail body is fixed to the second link to move together therewith between the deployed and stowed positions.

In some embodiments, the upper siderail body has a lateral outer surface configured to face away from the patient support apparatus; a maximum lateral distance between the lateral outer surface of the upper siderail body and a pivot axis of the second frame joint is attained at a given intermediate position of the siderail between the deployed and stowed positions; and the maximum lateral distance is less than 10 inches.

In some embodiments, the upper siderail body has a lateral outer surface configured to face away from the patient support apparatus; a maximum lateral distance between the lateral outer surface of the upper siderail body and a pivot axis of the second frame joint is attained at a given intermediate position of the siderail between the deployed and stowed positions; and a displacement of the lateral outer surface in a lateral direction between the deployed position and the given intermediate position is less than 5 inches.

In some embodiments, the siderail includes a latch system for locking the siderail in the deployed position, the latch system blocking the movement of the linkage assembly in the deployed position and being selectively unlockable to permit the movement of the linkage assembly to thereby move the siderail to the stowed position.

In some embodiments, the siderail includes a damper for damping a descent of the siderail from the deployed position to the stowed position, at least a majority of the damper remaining concealed throughout a motion of the siderail between the deployed and stowed positions In some embodiments, the damper is connected between the first link and the second link.

In some embodiments, the second link comprises an internal cavity, at least a majority of the damper being disposed within the internal cavity.

In some embodiments, the siderail includes the frame connector, the frame connector being configured to be mounted to a part of the patient support apparatus.

In some embodiments, a patient support apparatus comprises a base; and upper frame operatively connected to the base; and deck for supporting a patient; and the siderail disposed along a periphery of the deck.

In some embodiments, the deck includes an upper body deck section that can be selectively raised and lowered relative to the upper frame to adjust an angle of the upper body of the patient relative to a lower body of the patient; and the siderail is mounted to the upper body deck section so as to move together therewith.

In some embodiments, the frame connector is mounted to a frame of the upper body deck section.

In some embodiments, in the stowed position, a vertical distance between the upper end of the upper siderail body and a top face of the deck when the deck is in a flat horizontal position is less than 3 inches

In some embodiments, in the stowed position, the upper siderail body extends laterally inwardly from the upper end to the lower end thereof.

In accordance with another aspect, there is provided a siderail for a patient support apparatus, comprising: an upper siderail body; a lower siderail body; a linkage assembly operatively connected to the upper and lower siderail bodies and configured to guide movement of the siderail between a deployed position and a stowed position, in the deployed position, the upper siderail body being disposed above the lower siderail body so that the siderail has a deployed height defined between an upper end of the upper siderail body and a lower end of the lower siderail body, in the stowed position, the lower siderail body being disposed at least partly behind the upper siderail body so that the siderail has a stowed height defined between the upper end of the upper siderail body and a lower end of the upper siderail body, the deployed height being greater than the stowed height, the linkage assembly forming a six-bar linkage.

In some embodiments, the lower siderail body is pivotably connected to the upper siderail body or independent therefrom.

In accordance with another aspect, there is provided a siderail for a patient support apparatus, comprising: an upper siderail body; a lower siderail body; a linkage assembly operatively connected to the upper and lower siderail bodies and configured to guide movement of the siderail between a deployed position and a stowed position, in the deployed position, the upper siderail body being disposed above the lower siderail body so that the siderail has a deployed height defined between an upper end of the upper siderail body and a lower end of the lower siderail body, in the stowed position, the lower siderail body being disposed at least partly behind the upper siderail body so that the siderail has a stowed height defined between the upper end of the upper siderail body and a lower end of the upper siderail body, the deployed height being greater than the stowed height, the lower siderail body being independent from the upper siderail body.

Embodiments of the invention each may have at least one of the above-mentioned objects and/or aspects, but do not necessarily have all of them. It should be understood that some aspects of the invention that have resulted from attempting to attain the above-mentioned objects may not satisfy these objects and/or may satisfy other objects not specifically recited herein.

Additional and/or alternative features, aspects, and advantages of embodiments will become apparent from the following description, the accompanying drawings, and the appended claims.

### BRIEF DESCRIPTION OF THE DRAWINGS

Having thus generally described the nature of the invention, reference will now be made to the accompanying drawings, showing by way of illustration example embodiments thereof and in which:

FIG. 1 is a top perspective view of a hospital bed in according with an embodiment of the present invention;

FIG. 2 is a perspective view, taken from a top, front side, of a siderail of the bed of FIG. 1, shown in a deployed position; and

FIG. 3 is a perspective view, taken from a top, rear side, of the siderail of FIG. 2;

FIG. 4 is a front elevation view of the siderail of FIG. 2;

FIG. 5 is a side elevation view of the siderail of FIG. 2;

FIG. 6 is a perspective view, taken from a top, front side, of the siderail of FIG. 2, shown in an intermediate position;

FIG. 7 is a perspective view, taken from a top, rear side, of the siderail of FIG. 6;

FIG. 8 is a side elevation view of the siderail of FIG. 6;

FIG. 9 is a perspective view, taken from a top, front side, of the siderail of FIG. 2, shown in a stowed position;

FIG. 10 is a perspective view, taken from a top, rear side, of the siderail of FIG. 9;

FIG. 11 is a side elevation view of the siderail of FIG. 9;

FIG. 12 is a side elevation view of a schematic representation of the siderail of FIG. 2 in the deployed position;

FIG. 13 is a side elevation view of a schematic representation of the siderail of FIG. 2 in the intermediate position;

FIG. 14 is a side elevation view of a schematic representation of the siderail of FIG. 2 in the stowed position;

FIG. 15 is a perspective view, taken from a top, rear side, of a siderail body of the siderail of FIG. 2;

FIG. 16 is a perspective view, taken from a bottom, front side, of a linkage assembly of the siderail of FIG. 2;

FIG. 17 is a front elevation view of the linkage assembly of FIG. 16;

FIG. 18 is a cross-sectional view of part of the linkage assembly of FIG. 16, taken along line 18-18 in FIG. 17;

FIG. 19 is a perspective view, taken from a top, rear side, of a lower crank link of the linkage assembly of FIG. 16;

FIG. 20 is an exploded view of the lower crank link of FIG. 19;

FIG. 21 is a perspective view, taken from a bottom, front side, of part of the lower crank link of FIG. 19;

FIG. 22 is a perspective view, taken from a top, rear side, of an intermediate link of the linkage assembly of FIG. 16;

FIG. 23 is a side elevation view of the intermediate link of FIG. 22;

FIG. 24 is an exploded view of the intermediate link of FIG. 22;

FIG. 25A is a side elevation view of a schematic representation of the siderail in accordance with another embodiment, showing the siderail in the deployed position; and

FIG. 25B is a side elevation view of a schematic representation of the siderail of FIG. 25A, showing the siderail in the stowed position.

It will be noted that throughout the appended drawings, like features are identified by like reference numerals. To not unduly encumber the figures, some elements may not be indicated in some figures if they were already identified in a preceding figure. It should be understood herein that elements of the drawings are not necessarily depicted to scale. Some mechanical or other physical components may also be omitted in order to not encumber the figures.

### DETAILED DESCRIPTION

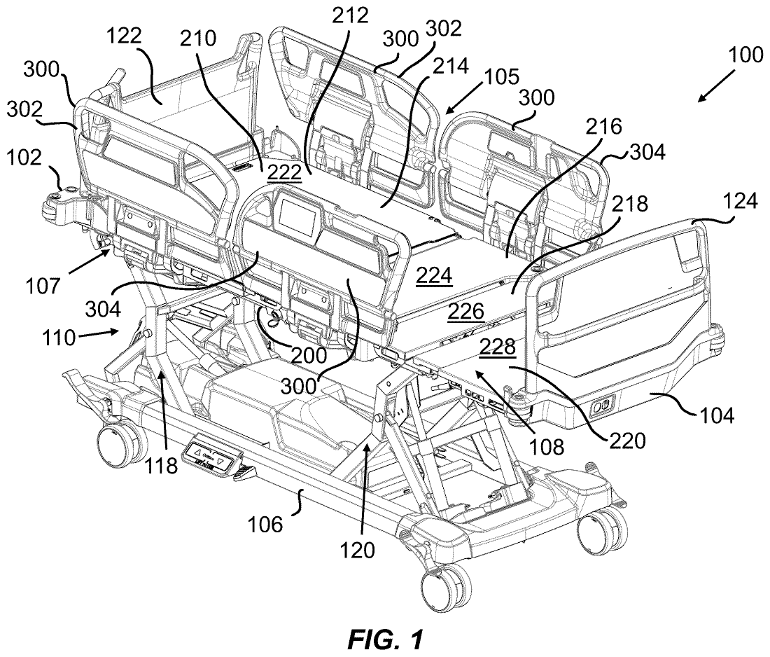

A patient support apparatus 100 in accordance with an embodiment of the present invention is illustrated in FIG. 1. The patient support apparatus 100 may be used in a medical setting for supporting a patient. In this embodiment, the patient support apparatus 100 is a hospital bed 100 that is used in a hospital, for example in an intensive care unit (ICU) setting. It is contemplated that, in other embodiments, the patient support apparatus 100 may be a different type of patient support apparatus such as, for example, a stretcher, a motorized chair, an operating room table, or other specialty tables (e.g., an examination table).

With reference to FIG. 1, the bed 100 has a head end 102 and a foot end 104 opposite each other and defining a length of the bed 100 therebetween. As will be appreciated, in use, when the patient is lying on the bed 100, the patient's head is closer to the head end 102 while the patient's feet are closer to the foot end 104. The bed 100 also has left and right sides 105, 107 extending between the head end 102 and the foot end 104 and defining a width of the bed 100 therebetween.

Some of the structural components of the bed 100 will be designated hereinafter as “right”, “left”, “head” and “foot” from the reference point of an individual lying on their back on the bed 100 with their head oriented toward the head end 102 of the bed 100 and their feet oriented toward the foot end 104 of the bed 100. Similarly, the term “headward” refers to an element located towards the head end 102 of the bed 100 and the term “footward” refers to an element located towards the foot end 104 of the bed 100. Furthermore “interior” and “exterior” views are also designated from the reference point of the patient lying in the bed. Therefore, an interior view shows an element as seen by the patient looking toward the environment outside of the bed and an exterior view shows an element as seen by a person outside of the bed. Generally, an exterior view shows the exterior surfaces of the bed and the interior view shows the interior surfaces of the bed. The terms “inner” and “outer” will similarly be used to describe the position of elements relative to the bed.

The bed 100 has a base 106 and a patient support assembly 108 operatively connected to the base 106. Four casters 114 are connected to the base 106 at respective corners thereof to allow the bed 100 to be moved along a floor. Additional casters may be provided in other embodiments. Respective brakes 116 are provided for each caster 114 to selectively lock and unlock the casters 114. The bed 100 may also have a drive wheel (not shown) connected to the base 106 for driving the bed 100 on the floor.

The patient support assembly 108, which is disposed above the base 106, is configured to accommodate the patient thereon and includes an upper frame 200 and a deck 210 supported by the upper frame 200. The upper frame 200 extends from a head end to an opposite foot end. The upper frame 200 has left and right longitudinal rails (not shown) that extend parallel to each other and are interconnected by a plurality of transversal members (not shown) extending therebetween. The upper frame 200 may be configured in any suitable manner in other embodiments.

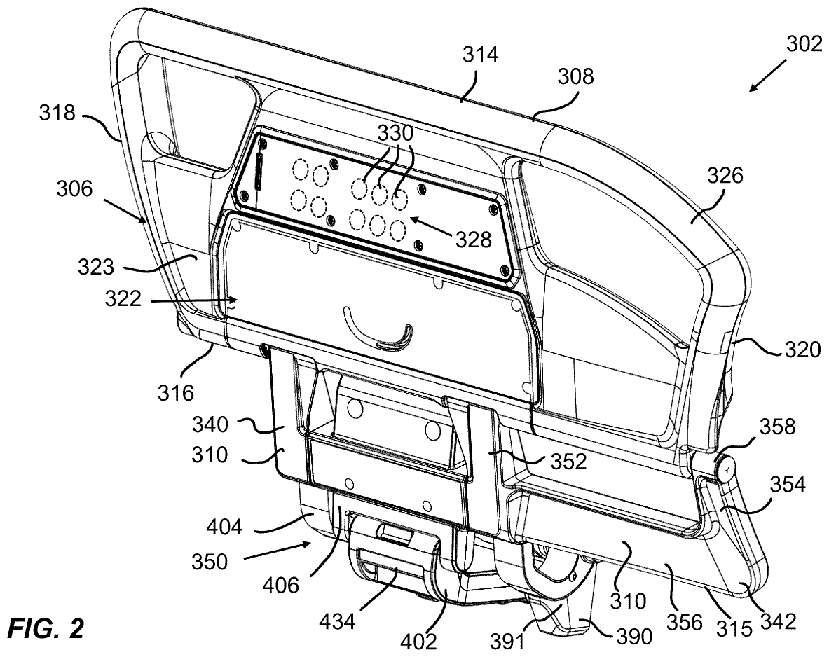

With reference to FIG. 2, the deck 210 defines a top face 212 on which a support surface such as a mattress or the like is supported. The deck 210 includes a plurality of deck sections that are connected to the frame 200 and, in use, support different areas of the patient's body. Notably, the deck sections forming the deck 210 include an upper body deck section 214 for supporting an upper body of the patient, a seat deck section 216 for supporting the patient's upper legs area, a thigh deck section 218 for supporting the patient's thighs, and a foot deck section 220 for supporting the patient's lower legs and feet. The deck sections 214, 216, 218, 220 are longitudinally consecutive to each other and together form the top face 212. Notably, the upper body deck section 214, seat deck section 216, thigh deck section 218 and foot deck section 220 have an upper body deck section panel 222, a seat deck section panel 224, a thigh deck section panel 226 and a foot deck section panel 228, respectively. Together, the deck section panels 222, 224, 226, 228 define respective top faces that, together form the top face 212 of the deck 210.

The deck sections 214, 216, 218, 220 are movably connected to each other. In particular, the upper body deck section 214 and the thigh deck section 218 are pivotably connected to the seat deck section 216. The foot deck section 220 is pivotably connected to the thigh deck section 218. The seat deck section 216 is fixed to the upper frame 200 but is also movable with a movable portion of the upper frame 200. In this embodiment, the movement of the foot deck section 220 as the bed 100 transitions between different positions is dependent on the movement of the other deck sections, namely of the thigh deck section 218 to which it is connected. That is, in this embodiment, the foot deck section 220 is not directly acted upon by an actuator external to the foot deck section 220 in order to change its position. Instead, the foot deck section 220 follows the motion described by the actuation of the thigh deck section 218. The articulation of the deck sections 214, 216, 218, 220 is described in greater detail in International Application Publication No. WO2024154074, published on Jul. 25, 2024, the entirety of which is incorporated by reference herein.

It is contemplated that fewer deck sections may be provided in other embodiments (e.g., three deck sections).

Referring back to FIG. 1, the bed 100 has a plurality of barriers generally disposed around the patient support assembly 108 including a headboard 122 at the head end 102, a footboard 124 at the foot end 104, and at least one siderail 300 on the left and right sides 105, 107. The siderails 300 can be raised to a deployed position to prevent the patient from falling off the bed 100 or lowered to a stowed position to allow the patient to exit the bed 100 and/or to allow care providers to access and attend to the patient. In the embodiment shown in FIG. 1, the siderails 300 include two siderails on each side 105, 107, namely a head siderail 302 and a foot siderail 304. The siderails 300 will be described in greater detail further below.

An elevation system 110 operatively connects the patient support assembly 108 to the base 106 to move the patient support assembly 108 relative to the base 106, namely selectively raising or lowering the patient support assembly 108 relative to the base 106. In addition to raising and lowering the patient support assembly 108, the elevation system 110 also allows the bed 100 to assume various different positions such as a flat horizontal position (shown in FIG. 1), a Trendelenburg position, a reverse Trendelenburg position, a cardiac chair position and a full chair position. It is contemplated that, in other embodiments, the bed 100 may be configured to assume more or fewer positions. For instance, in some cases, the bed 100 may permanently remain in the flat horizontal position and simply be raised and lowered by the elevation system 110.

In this embodiment, the elevation system 110 includes a head end lift assembly 118 and a foot end lift assembly 120 which connect the base 106 to a head end portion and a foot end portion of the upper frame 200, respectively. Each of the head end lift assembly 118 and the foot end lift assembly 120 may be raised to a fully extended position and lowered to a fully collapsed position. The lift assemblies 118, 120 may be controlled symmetrically so that that the lift assemblies 118, 120 are in equivalent extended positions at the same time (e.g., both in the fully extended position or both in the fully collapsed position), or they may also be controlled asymmetrically so that they are in different extended positions at the same time. For example, in some cases, the head end lift assembly 118 may be in the fully extended position while the foot end lift assembly 120 is in the fully collapsed position or vice-versa (e.g., in the Trendelenburg position).

The bed 100 has many other features that will not be described in detail herein as they are well known in the art. The above description of the bed 100 is thus not meant to be exhaustive but rather to provide sufficient context for the reader.

The siderails 300 will now be described in greater detail. Specifically, the right one of the head siderails 302 (i.e., on the right side 107 of the bed 100) will be described in detail herein, the left one of the head siderails 302 being a mirror image thereof. Although the foot siderails 304 have a different shape and dimensions from the head siderails 302, they have the same mechanical configuration and thus their functionality can be readily understood from the below description as well. The foot siderails 304 will therefore not be described in detail herein as the reader may refer to the description of the head siderails 302 to understand the working of the foot siderails 304.

With reference to FIGS. 2 to 5, the siderail 302 has a siderail body 306 constituting the part of the siderail 302 that blocks egress of the patient from the bed 100. The siderail 302 also has a linkage assembly 350 which, as will be explained in greater detail below, operatively connects the siderail body 306 to the frame of the upper body deck section 214 and guides movement of the siderail 302 between the deployed and stowed positions.

The siderail body 306 includes an upper siderail body 308 and a lower siderail body 310 that, in this embodiment, is pivotably connected to the upper siderail body 308. The upper siderail body 308 has an upper end 314 and a lower end 316 that extend longitudinally. A height of the upper siderail body 308 is defined between the upper and lower ends 314, 316. The upper siderail body 308 also has two longitudinal ends, namely a head end 318 and a foot end 320, defining a length of the upper siderail body 308 therebetween. A thickness of the upper siderail body 308 is defined between a lateral outer side 322 that faces away from the deck 210 and a lateral inner side 324 that faces inwardly towards the deck 210. The upper siderail body 308 also has a handle portion 326 configured for grasping by the patient. This can be useful for example for the patient to egress from a side of the bed 100.

As shown in FIG. 2, in this embodiment, the upper siderail body 308 has a user interface 328 on the lateral outer side 322 for receiving inputs from a user. In particular, the user interface 328 includes a plurality of control elements 330 for operating different functionalities of the bed 100. For instance, the control elements 330 may include position control elements to actuate different parts of the bed 100, including for example the elevation system 110 and the deck sections of the bed 100. In this example, the control elements 330 are buttons that are selectively depressed by the user to activate or deactivate the associated function. In some cases, the user interface 328 may include a touch screen and the control elements 330 may be icons displayed on the touch screen. A controller (not shown) is in communication with the control elements 330 to receive the commands therefrom.

A patient interface (not shown) may be disposed on the lateral inner side 324 of the upper siderail body 308 (i.e., facing the patient) to allow the patient to input commands that control different features of the bed 100, including for example position changes of the different deck sections.

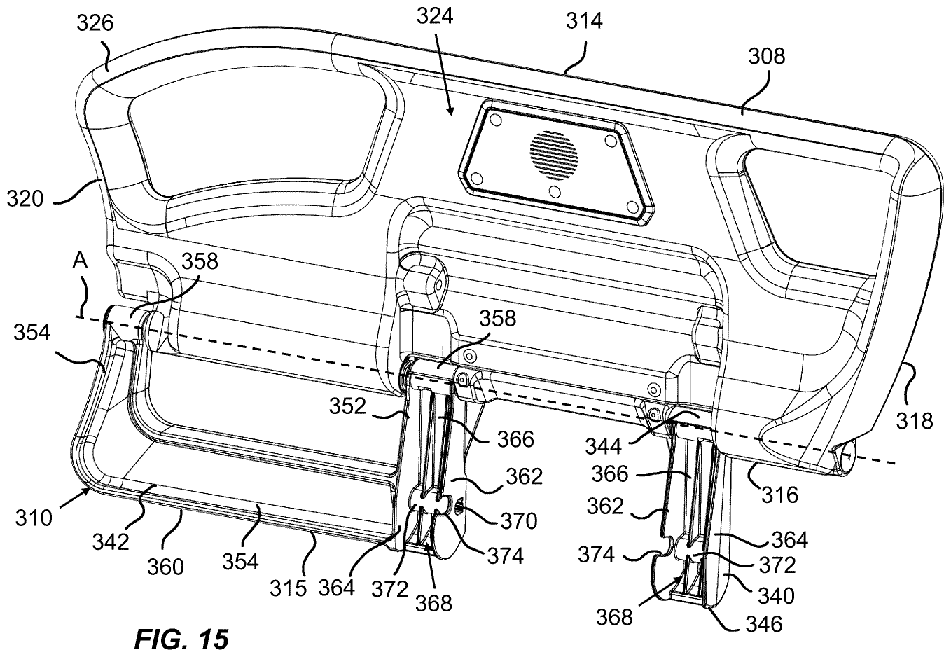

With particular reference to FIG. 15 which shows the siderail body 306 in isolation, the lower siderail body 310 includes a head lower siderail member 340 and a foot lower siderail member 342 that are longitudinally spaced from each other. In this embodiment, the foot lower siderail member 342 is generally U-shaped, having an inner arm 352, an outer arm 354 and a central portion 356 extending between the inner and outer arms 352, 354. Each arm 352, 354 defines a corresponding proximal end 358 of the foot lower siderail member 342. In this embodiment, the proximal ends 358 are pivotably connected to the upper siderail body 308 about a pivot axis A that extends longitudinally. A distal end 360 of the foot lower siderail member 342 is defined by the central portion 356. In this embodiment, the inner arm 352 has an inner sidewall 362, an outer sidewall 364 and a bottom wall 366 that define a recess 368 that can receive part of the linkage assembly 350 therein as will be described in more detail further below. The recess 368 may be omitted in other embodiments. An opening 370 is defined in the inner sidewall 362 for receiving a member that connects the linkage assembly 350 to the foot lower siderail member 342. The opening 370 opens into a sleeve 372 extending between the sidewalls 362, 364. The inner sidewall 362 also defines a slot 374 which receives part of the linkage assembly 350 as will be described in detail further below.

In this embodiment, the head lower siderail member 340 is shaped differently from the foot lower siderail member 342. Notably, the head lower siderail member 340 extends generally linearly between a proximal end 344 and a distal end 346. The proximal end 344 is pivotably connected to the upper siderail body 308 about the pivot axis A. As such, the entirety of the lower siderail body 310 is pivotable relative to the upper siderail body 308 about the pivot axis A. As will be appreciated, in this embodiment, the head lower siderail member 340 is a mirror image of the inner arm 352 of the foot lower siderail member 342. The same reference numerals used to identify the parts of the inner arm 352 have therefore been used to identify the various parts of the head lower siderail member 342.

As will be understood, in this embodiment, the shape of the head lower siderail member 340 leaves a gap between the lower end 316 of the upper siderail body 308 and the top face 212 of the deck 210 when the siderail 302 is raised (as shown in FIG. 1 for example). This gap may be at least in part filled by a mattress retainer that is fixed to the patient support assembly 308. Such mattress retainers are known and therefore will not described further herein.

It is contemplated that the head and foot lower siderail members 340, 342 could be shaped differently in other embodiments. For instance, the shape of the head lower siderail member 340 could be identical to the shape of the foot lower siderail member 342. In other embodiments, the head and foot lower siderail members 340, 342 may each have a generally rectangular shape, an L-shape or any other suitable shape.

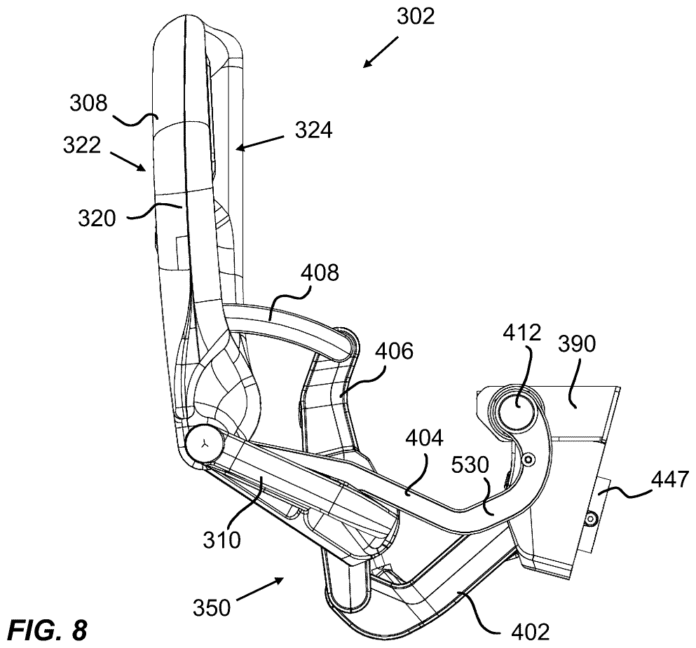

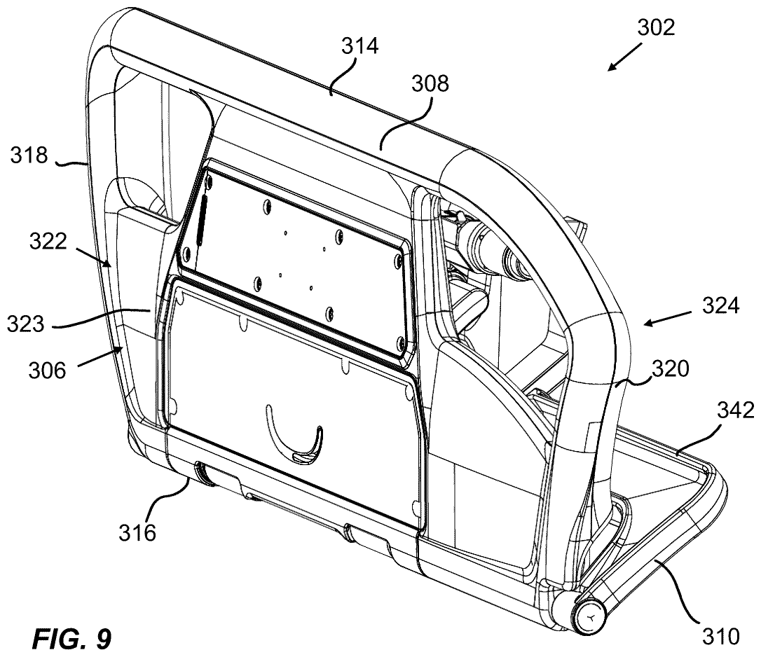

With reference to FIGS. 2 to 11, the linkage assembly 350 operatively connects the upper and lower siderail bodies 308, 310 to a frame connector 390 that is fixed to the upper body deck section 214. In particular, the frame connector 390 is mounted to a frame (not shown) of the upper body deck section 214. The siderail 302 therefore moves together with the upper body deck section 214 when the inclination of the upper body deck section 214 is adjusted (e.g., when the upper body deck section 214 is raised). The frame connector 390 could instead be connected to the frame 200 of the bed 100 in other embodiments. Moreover, the frame connector 390 could be integrated as part of the upper body deck section 214 or another part of the bed 100, instead of being integrated as part of the siderail 302. As will be explained in detail below, the linkage assembly 350 guides the movement of the upper and lower siderail bodies 308, 310 between the deployed and stowed positions. The linkage assembly 350 includes a lower crank link 402, an upper crank link 404, an intermediate link 406, and an upper connecting link 408 which are pivotably connected to each other and together define the path of the upper and lower siderail bodies 308, 310 as the siderail 302 is moved between the deployed and stowed positions.

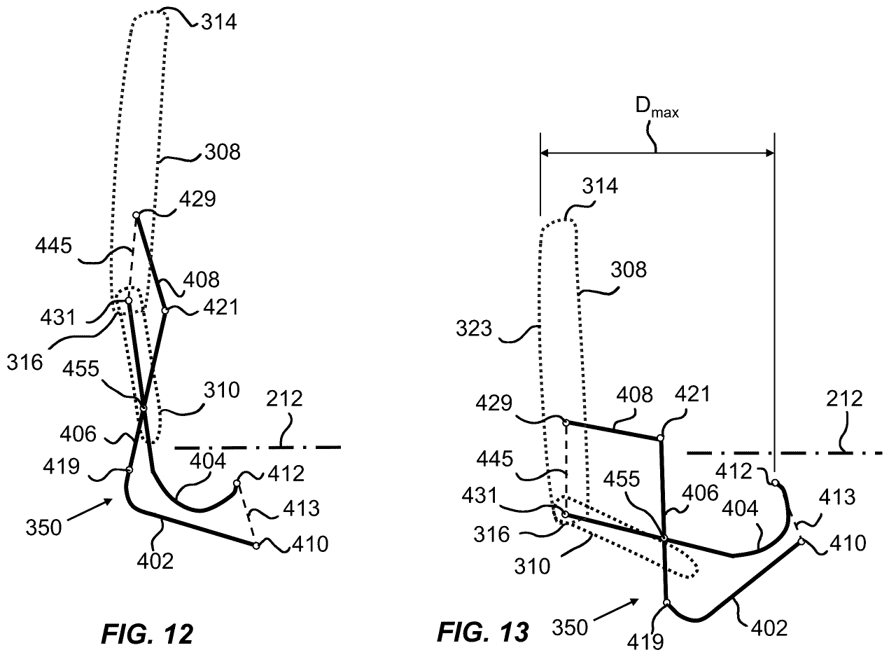

Reference will now be made to the schematic representations of the linkage assembly 350 illustrated in FIGS. 12 to 14, showing a transition of the siderail 302 between the deployed position and the stowed position. The lower crank link 402 and the upper crank link 404 are pivotably connected to the frame connector 390 at lower and upper frame joints 410, 412 respectively. The lower and upper frame joints 410, 412 are thus fixed relative to the part of the bed 100 to which the frame connector 390 is mounted, namely the frame of the upper body deck section 214 in this embodiment. The upper frame joint 412 is positioned vertically higher than the lower frame joint 410 and laterally outwardly of the lower frame joint 412.

The lower and upper frame joints 410, 412 are interconnected by a frame link 413, illustrated in dashed lines, which is representative of the frame connector 390 (or other structure to which the siderail 302 could be connected). The frame link 413 is a ground link and thus remains fixed in place relative to the frame connector 390 when the linkage assembly 350 is in motion. As such, the pivot axes defined by the lower and upper frame joints 410, 412 remain fixed in place relative to the frame connector 390.

The lower crank link 402 and the upper crank link 404 are also respectively pivotably connected to the intermediate link 406 and the upper siderail body 308. In particular, the lower crank link 402 is pivotably connected to the intermediate link 406 at a lower connecting joint 419. An opposite end of the intermediate link 406 is pivotably connected to the upper connecting link 408 at an upper connecting joint 421. The upper connecting joint 421 is disposed vertically higher than the lower connecting joint 419 irrespective of the position of the siderail 302. For its part, the upper crank link 404 is pivotably connected to the upper siderail body 308 at a lower body joint 431. The lower body joint 431 is positioned near the lower end 316 of the upper siderail body 308. Notably, in this embodiment, the lower body joint 431 is generally coaxial with the pivot axis A (FIG. 15).

The upper connecting link 408 connects the upper siderail body 308 to the intermediate link 406. More specifically, the upper connecting link 408 is pivotably connected at one end thereof to the intermediate link 406 at the upper connecting joint 421, and is also pivotably connected at an opposite end to the upper siderail body 308 at an upper body joint 429. The upper body joint 429 is disposed vertically higher than the lower body joint 431. The upper body joint 429 and the lower body joint 431 are interconnected by a body link 445, illustrated in dashed lines, which is representative of the upper siderail body 308. The body link 445 is thus a coupler link.

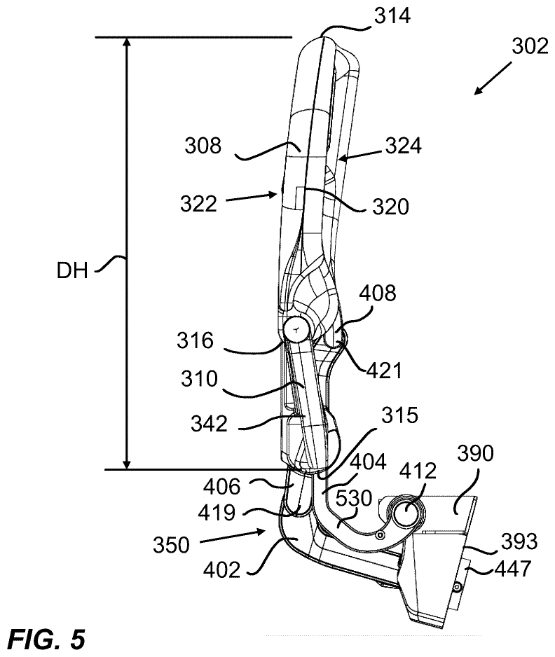

The upper crank link 404 and the intermediate link 406 are ternary links as they each have three joints. In particular, in addition to the joints described above, the upper crank link 404 and the intermediate link 406 are pivotably connected to each other at an intermediate joint 455. The intermediate joint 455 is disposed, along the intermediate link 406, between the lower and upper connecting joints 419, 421. Along the upper crank link 404, the intermediate joint 455 is disposed between the upper frame joint 412 and the lower body joint 431. The connection between the upper crank link 404 and the intermediate link 406 results in the upper crank link 404 extending through the intermediate link 406, in a side elevation view of the linkage assembly 350, irrespective of the position of the siderail 302. In other words, when looking at the linkage assembly 350 from the side (such as in FIGS. 5, 8, 11 and 12 to 14), the upper crank link 404 can be seen crossing the intermediate link 406.

As will be appreciated, the linkage assembly 350 forms a six-bar linkage together with the upper siderail body 308 and the frame connector 390. Notably, it can be observed in FIGS. 12 to 14 that the links 402, 404, 406, 408 of the linkage assembly 350 together with the body link 445 and the frame link 413, total six links and seven joints.

As will be described below, the configuration of the linkage assembly 350 described above enables the siderail body 306 to collapse as the siderail 302 transitions between the deployed position and the stowed position. Starting from the deployed position, the siderail body 306 is positioned to block the patient's egress from the bed 100. Notably, with reference to FIGS. 2 to 5, in the deployed position, the upper siderail body 308 is disposed above the lower siderail body 310 such that the siderail 302 has a deployed height DH (FIG. 5) defined between the upper end 314 of the upper siderail body 308 and a lower end 315 of the lower siderail body 310 (corresponding to the distal ends 346, 360 of the head and foot lower siderail members 340, 342). The deployed height DH is appropriate to block egress of a patient from the bed 100. In the deployed position, the upper end 314 of the upper siderail body 308 is disposed considerably higher than the top face 212 of the deck 210 (represented schematically in FIGS. 12 to 14) when the deck 210 is in the flat horizontal position, as illustrated in FIG. 1. For example, the upper end 314 of the upper siderail body 308 is set at about 17 inches from the top face 212 of the deck 210 when the top face 212 is in the flat horizontal position. In addition, as can be observed from the body link 445 in FIG. 12 (which is representative of the upper siderail body 308), in the deployed position, the upper siderail body 308 extends generally vertically, notably extending slightly laterally inwardly from the lower end 316 to the upper end 314.

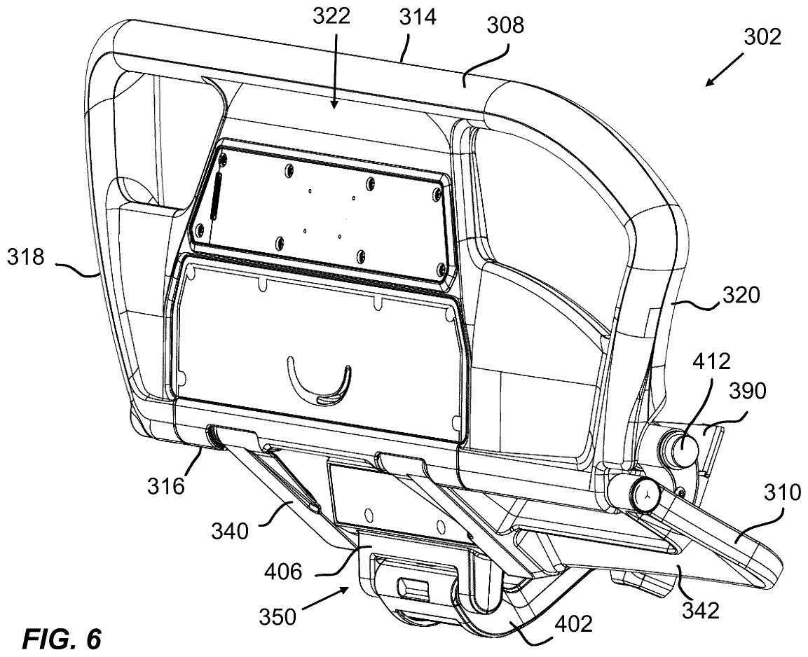

In order to transition to the stowed position, the lower and upper crank links 402, 404 undergo a downward rotation about the lower and upper frame joints 410, 412. As can be seen in FIG. 13 which schematically illustrates the siderail 302 in one of many intermediate positions between the deployed and stowed positions, the upper siderail body 308 moves laterally outwardly (i.e., away from the deck 210) as the siderail 302 moves towards the stowed position, and the lower siderail body 310 begins pivoting relative to the upper siderail body 308 due to the connection between the lower siderail body 310 and the intermediate link 406. The intermediate position illustrated in FIGS. 6 to 8 and 13 corresponds to a laterally outermost position of the upper siderail body 308 (i.e., when it is most spaced from the deck 210). This intermediate position will thus be referred to as the “laterally outermost intermediate position” for ease of reference. In the laterally outermost intermediate position, the lateral distance between the upper siderail body 308 and the deck 210 is at its greatest. However, due to the path of the siderail body 306 as defined by the linkage assembly 350, this lateral distance is relatively small compared to conventional siderails with a folding functionality. For example, with reference to FIG. 13, at the laterally outermost intermediate position, a distance Dₘₐₓ between a lateral outer surface 323 of the upper siderail body 308 and the pivot axis of the upper frame joint 412 may be less than 10 inches. In this embodiment, the distance Dₘₐₓ is approximately 9.7 inches. This may reduce the amount of free space that is required on each lateral side of the bed 100 to move the siderail 302 between the deployed and stowed positions. For instance, a displacement of the lateral outer surface 323 in the lateral direction between the deployed position and the laterally outermost intermediate position may be less than 5 inches. In this example, the displacement of the lateral outer surface 323 in the lateral direction between the deployed and laterally outermost intermediate positions is approximately 4.7 inches.

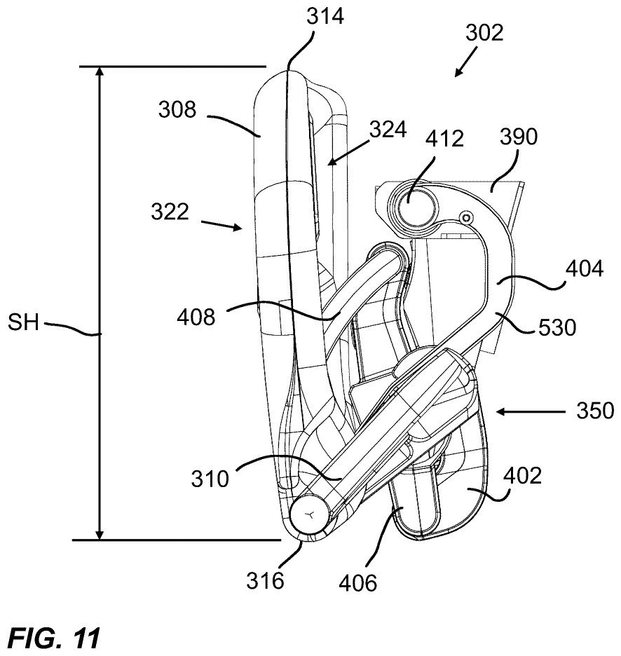

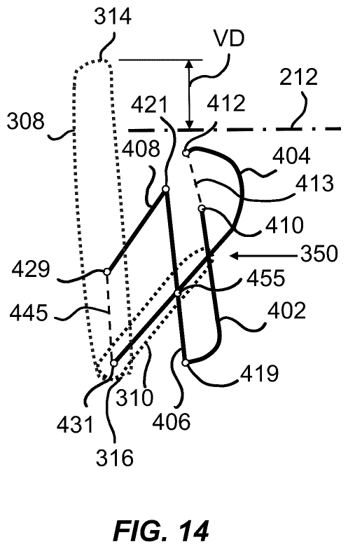

The upper siderail body 308 then starts retracting back towards the deck 210 as the siderail 302 keeps moving toward the stowed position. The lower siderail body 310 also keeps pivoting upward until, in the stowed position, the lower siderail body 310 is disposed laterally inwardly of the upper siderail body 308 (i.e., behind the upper siderail body 308). Thus, in the stowed position, the siderail 302 has a stowed height SH (FIG. 11) defined between the upper end 314 and the lower end 316 of the upper siderail body 308. In other words, the stowed height SH corresponds to the height of the upper siderail body 308. Therefore, the deployed height DH is greater than the stowed height SH. Furthermore, as best shown in FIG. 14, in the stowed position, a vertical distance VD between the upper end 314 of the upper siderail body 308 and the top face 212 of the deck 210 in the flat horizontal position of the deck 210 is considerably small. Notably, the vertical distance VD may be less than 3 inches. In this example, the vertical distance VD is approximately 2.3 inches. This may be helpful to facilitate a patient's egress from the side of the bed 100, namely so that the upper end 314 of the siderail 302 does not obstruct the patient's movement. Indeed, the vertical displacement of the upper end 314 from the deployed position to the stowed position is significant. For instance, the vertical displacement of the upper end 314 from the deployed position to the stowed position may be greater than 14 inches. In this example, the vertical displacement of the upper end 314 from the deployed position to the stowed position is approximately 15 inches.

With reference to FIG. 14, to transition to the stowed position, the upper connecting link 408 pivots downward about the upper connecting joint 421 such that, in the stowed position, the upper body joint 429 is disposed vertically lower than the upper connecting joint 421. Moreover, the linkage assembly 350 generally becomes more compact as the links 402, 404, 406, 408 pivot toward the stowed position. Indeed, in the stowed position, the lower crank link 402, the intermediate link 406 and the upper connecting link 408 overlap each other in the vertical direction, as can be seen in FIG. 14. The angular position of the intermediate link 406 varies relatively little as the siderail 302 moves between the deployed and stowed positions, generally remaining upright as the siderail 302 moves between both positions. Furthermore, with reference to FIGS. 11 and 14, in the stowed position, the upper siderail body 308 extends generally vertically, extending slightly laterally inwardly from the upper end 314 to the lower end 316. For instance, the angle formed by the upper siderail body 308 and a vertical plane extending longitudinally may be less than 10°. The orientation of the upper siderail body 308 can be gauged by drawing a line that extends through the upper end 314 and the pivot axis of the lower body joint 431. In this example, the angle formed by upper siderail body 308 and the vertical plane extending longitudinally may be less than 5°. This slight angulation of the upper siderail body 308 in the stowed position can be helpful to prevent the patient's ankles from substantially touching the upper siderail body 308 when the patient egresses from the side of the bed 100.

The links 402, 404, 406, 408 and the joints formed thereby will now be described in greater detail.

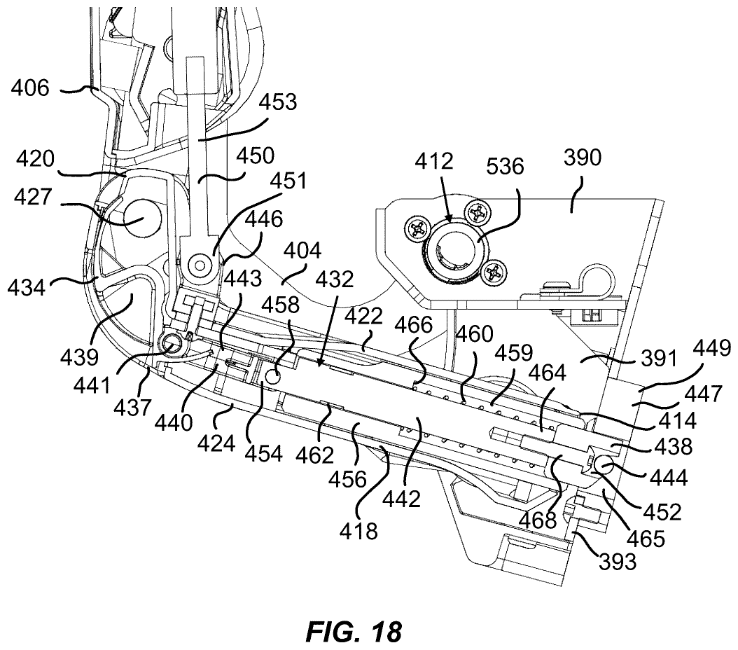

With reference to FIG. 18, the lower crank link 402 extends from a proximal end 414 to a distal end 416. The lower frame joint 410 is disposed near the proximal end 414, defining a pivot axis 415 about which the lower crank link 402 pivots during displacement of the siderail 302 between the deployed and stowed positions. The lower connecting joint 419 is disposed near the distal end 416, defining a pivot axis 417 about which the lower crank link 402 is pivotably connected to the intermediate link 406. The pivot axes 415, 417 extend longitudinally.

In this embodiment, the lower crank link 402 is generally L-shaped, having a generally straight portion 418 and an angled portion 420 that projects at an angle or curve from the straight portion 418. The straight portion 418 includes the proximal end 414, while the angled portion 420 includes the distal end 416. The lower crank link 402 could be shaped differently in other embodiments. For instance, the lower crank link 402 could extend linearly from the proximal end 414 to the distal end 416 in other embodiments.

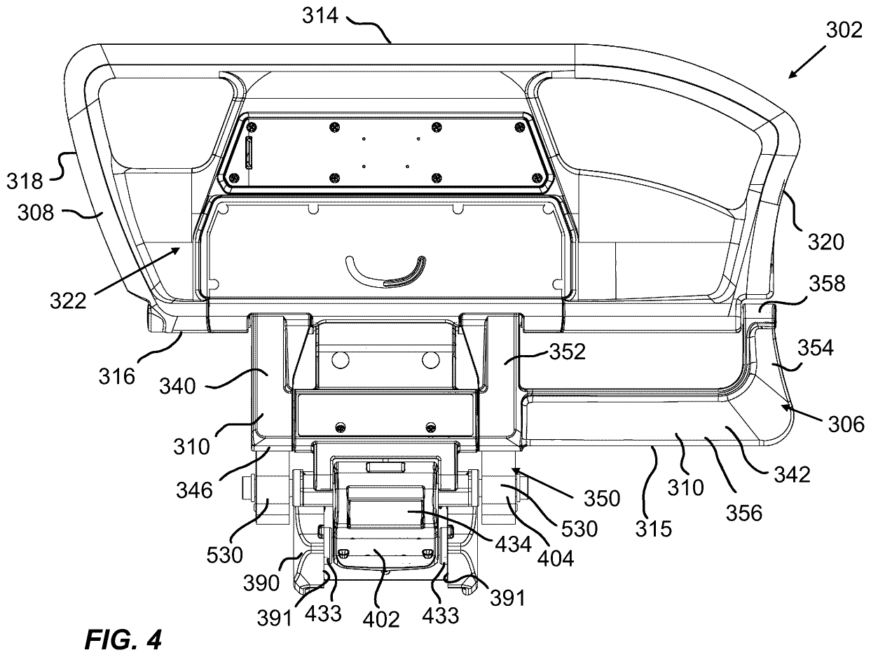

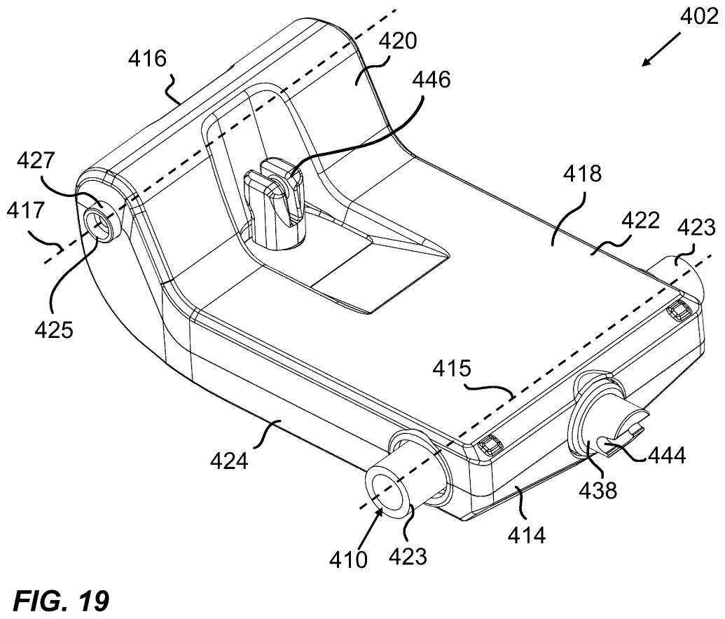

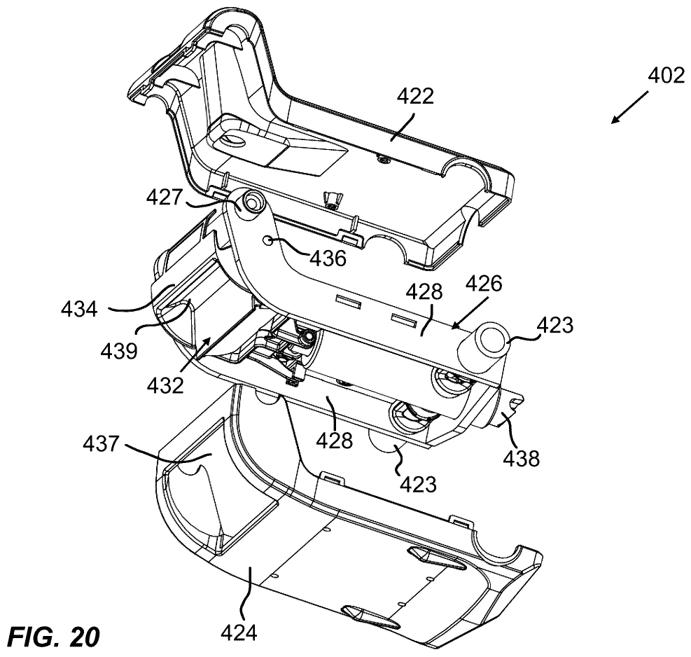

With particular reference to FIG. 19, the lower crank link 402 has an upper casing 422 and a lower casing 424 forming the exterior surfaces of the lower crank link 402. The lower crank link 402 also has a link frame 426 that is enclosed by the upper and lower casings 422, 424. The link frame 426 includes two side plates 428 and a central plate 430 (FIG. 20) extending between and connected (e.g., welded) to the side plates 428. The lower frame joint 410 is formed by two tubes 423 traversing respective ones of the side plates 428 and engaging bearings 433 (FIG. 4) that are fixed to respective sidewalls 391 of the frame connector 390. In some embodiments, the tubes 423 could instead be replaced by a single tube. The engagement between the tubes 423 with the bearings 433 form the lower frame joint 410. The lower connecting joint 419 is formed by a pivot shaft 427 traversing the side plates 428 and being mounted to two bushings (not shown) of the intermediate link 406.

In this embodiment, the lower crank link 402 has a latch system 432 for selectively unlocking the siderail 302 from the deployed position. The latch system 432 is supported by the link frame 426 and includes a latch handle 434 that is pivotably connected to the side plates 428 by prongs 435 (one of which is shown in FIG. 20) on the sides of the latch handle 434 engaging a respective pin 436 (FIG. 19) fixed to the side plates 428. The latch handle 434 is accessible through an opening 437 defined by the lower casing 424. The latch handle 434 defines a recess 439 for receiving a user's fingers and thereby allow the user to actuate the latch handle 434 by pulling upward on the latch handle 434.

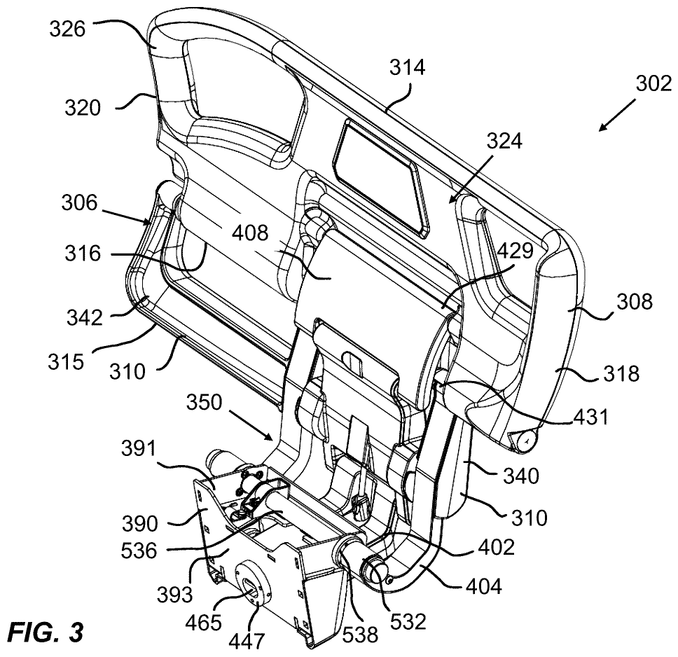

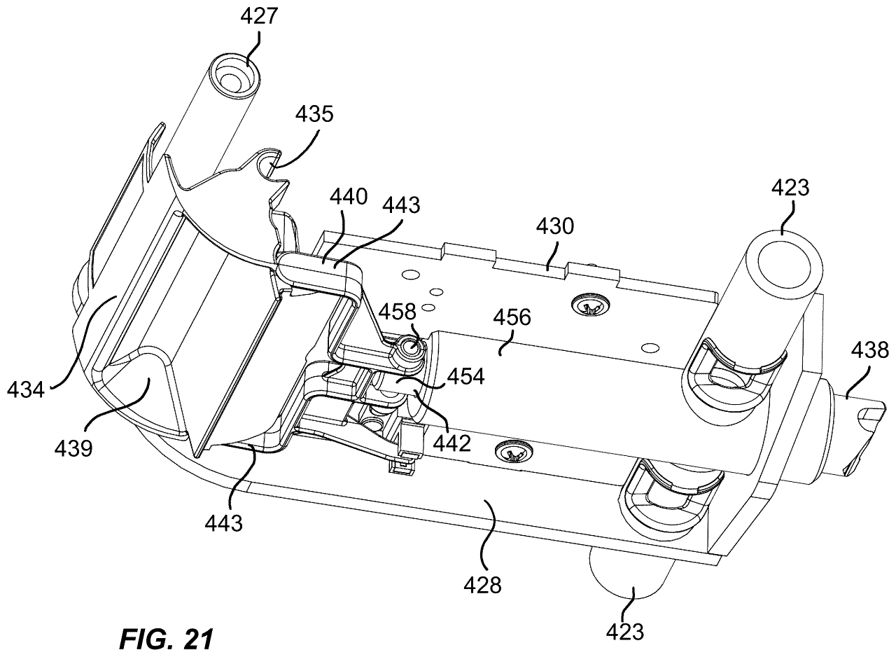

With reference to FIG. 19, the latch system 432 has a lock engager 438 that is operatively connected to the latch handle 434 and is configured to lockingly engage a locking base 447 (FIGS. 3, 5, 7) in the deployed position of the siderail 302 in order to secure the siderail 302 in its deployed position. More specifically, with reference to FIG. 21, the latch handle 434 is pivotably connected to an intermediate member 440 via respective protrusions 441 (one of which is shown in FIG. 18) provided at the ends of two arms 443 of the intermediate member 440, inserted into respective openings (not shown) of the latch handle 434. At an opposite end, the intermediate member 440 is pivotably connected to a first end 454 of a sliding shaft 442 by a pin 458. The sliding shaft 442 is slidable axially within a bore 459 of a tubular guide 456. The guide 456 is fixed to the central plate 430 of the link frame 426 and to the tubes 423. A bearing 462 is disposed around part of the sliding shaft 442 to facilitate sliding movement of the sliding shaft 442 relative to the guide 456. The lock engager 438 is fastened to a second end 464 of the sliding shaft 442 by a fastener 468. The lock engager 438 could be made integrally with the sliding shaft 442 in other embodiments. A spring 460 is received in the bore 459 and is compressed between the lock engager 438 and a shoulder 466 in the bore 459. The spring 460 thus biases the lock engager 438 away from the shoulder 466.

As can be seen, in the deployed position, the spring 460 biases the lock engager 438 toward a locked position thereof, whereby the lock engager 438 extends into an opening 465 of the locking base 447 and abuts a locking pin 444. In particular, the locking base 447 includes a collet 449 defining the opening 465 and the locking pin 444 extending across the opening 465. The locking base 447 is fixed to a rear wall 393 of the frame connector 390. When the lock engager 438 extends into the opening 465 and abuts the locking pin 444, the siderail 302 is prevented from descending towards the stowed position as downward rotation about the lower and upper frame joints 410, 412 of the linkage assembly 350 is not permitted by the engagement of the lock engager 438 with the locking base 447. A groove 452 defined by the lock engager 438 receives the locking pin 444, preventing axial movement of the lock engager 438 away from the shoulder 466.

It is contemplated that the locking base 447 could be configured differently in other embodiments.

As will be appreciated, by pulling upwardly on the latch handle 434, the sliding shaft 442 slides axially so as to retract the lock engager 438 within the bore 459 of the guide 456. In particular, the lock engager 438 compresses the spring 460 against the shoulder 466 until the lock engager 438 disengages the locking base 447. Once the lock engager 438 has disengaged the locking base 447, the weight of the siderail 302 causes downward rotation of the lower crank link 402 and the upper crank link 404 about the lower and upper frame joints 410, 412 such that the siderail 302 descends towards the stowed position.

While in this embodiment the latch system 432 is integrated in the lower crank link 402, the latch system 432 could be placed elsewhere in the linkage assembly 350. Notably, in other embodiments, the latch system 432 could be integrated into any other one of the links 404, 406, 408 to selectively prevent the rotation thereof in the deployed position. In such cases, the locking base 447 could be positioned elsewhere, such as in another link.

Furthermore, in other embodiments, the latch system 432 could be omitted or replaced by a less sophisticated mechanism for locking the siderail 302 in the deployed position (e.g., a removable pin that prevents movement of the linkage assembly 350).

As best shown in FIG. 19, in this embodiment, the lower crank link 402 also has a damper mount 446 for connecting a damper 450 (FIG. 18) configured for damping the descent of the siderail 302 from the deployed position to the stowed position. In particular, a moving end 451 of the damper 450, connected to a piston rod 453, is connected to the damper mount 446. The damper mount 446 is connected to the central plate 430 of the link frame 426 and protrudes through the upper casing 422. The damper mount 446 is positioned near an intersection between the straight portion 418 and the angled portion 420 of the lower crank link 402. Notably, from the lateral outer side of the siderail 302, the damper mount 446 is concealed by the angled portion 420. As will be described further below, an opposite end of the damper 450 is connected to the intermediate link 406.

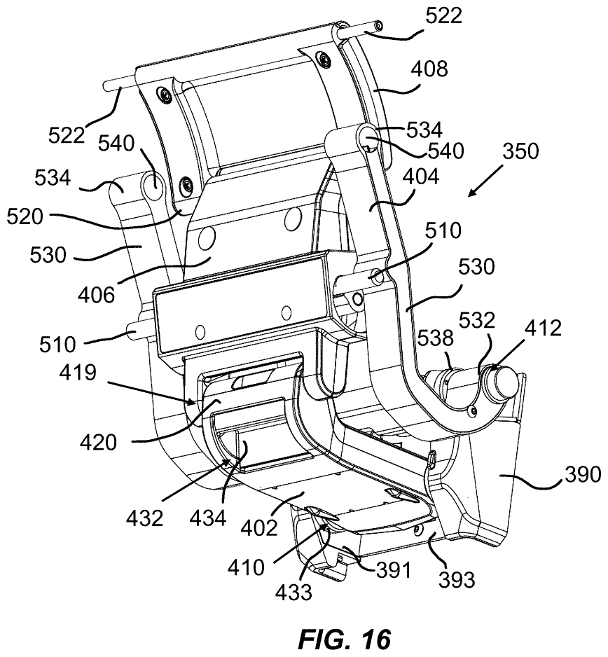

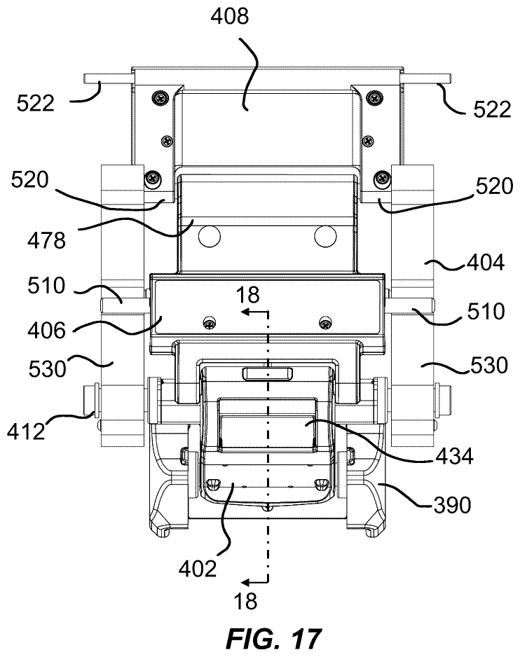

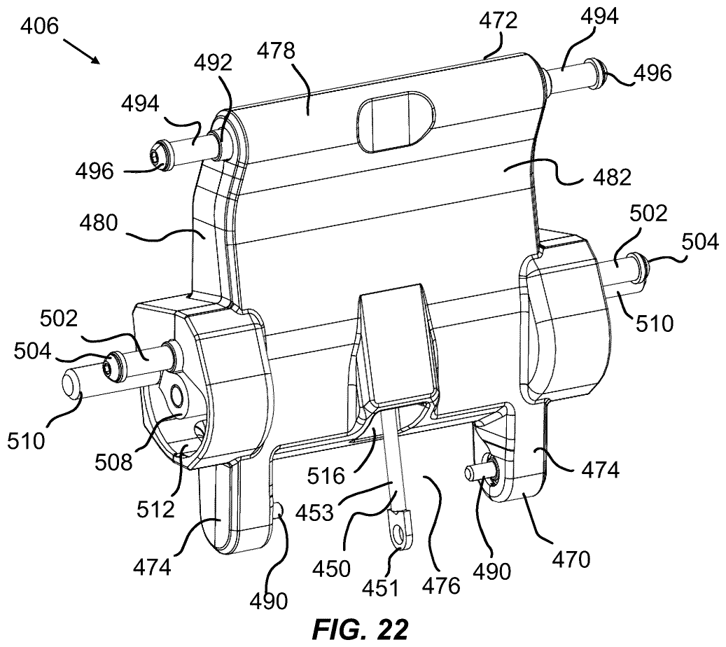

With reference to FIGS. 22 to 24, the intermediate link 406 extends from a lower end 470 to an upper end 472. The intermediate link 406 has two lower arms 474 defining the lower end 470. The two lower arms 474 are longitudinally spaced from each other to define a recess 476 therebetween. As can be seen in FIGS. 16 and 17, the angled portion 420 of the lower crank link 402 is received in the recess 476. An outer body 478 of the intermediate link 406 includes an outer casing 480 and an inner casing 482 facing laterally outwardly and laterally inwardly respectively. The outer and inner casings 480, 482 are affixed to each other to define an interior cavity of the outer body 478.

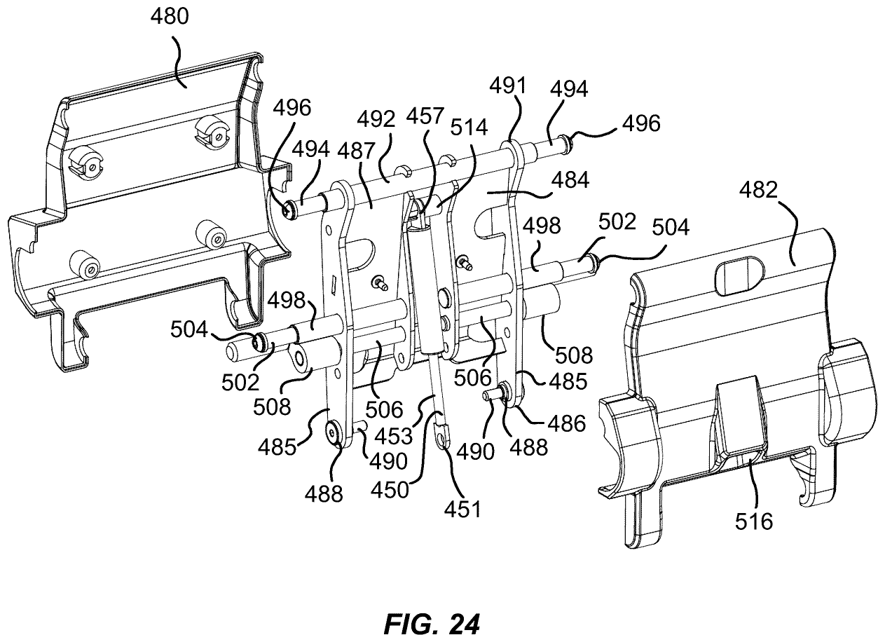

As shown in FIG. 24, a link frame 484 is contained within the cavity of the outer body 478. The link frame 484 supports various shafts used for implementing the joints of the intermediate link 406. The link frame 484 has two side flanges 485 spaced from each other and interconnected by a frame body 487. A lower end 486 of the link frame 484, defined by the two side flanges 485, supports two bushings 488 and fasteners 490 extending through the bushings 488. The fasteners 490 are secured to the pivot shaft 427 (FIGS. 19-21) to form the lower connecting joint 419. The link frame 484 has, at an upper end 491 thereof, a shaft 492 extending longitudinally through both side flanges 485. Two bushings 494 are connected to the ends of the shaft 492 outward of the side flanges 485 by fasteners 496. The bushings 494 receive part of the upper connecting link 408 to form the upper connecting joint 421. The shaft 492 and the bushings 494 thus define the pivot axis of the upper connecting joint 421.

The link frame 484 also includes two shafts 498 disposed around a middle portion of the link frame 484 (i.e., around halfway between the lower and upper ends 486, 491). The shafts 498 extend longitudinally and are coaxial with each other. Two bushings 502 are connected to the outer ends of the shafts 498 by fasteners 504. The bushings 502 receive part of the upper crank link 404 to form the intermediate joint 455. The shafts 498 and the bushings 502 thus define the pivot axis of the intermediate joint 455. In this embodiment, in the deployed position of the siderail 302, the shafts 498 are received in the slots 374 (FIG. 15) defined by the lower siderail members 340, 342.

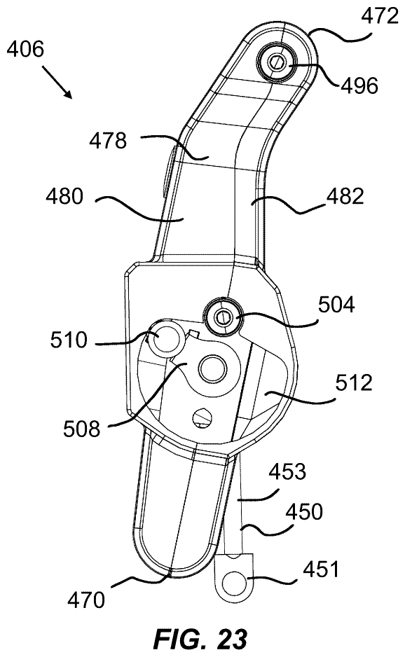

With continued reference to FIG. 24, the link frame 484 further includes two support shafts 506 extending longitudinally and coaxial with each other. A connecting rod 508 is pivotably connected to an end of each support shaft 506 outward of the side flanges 485. A driving rod 510 is connected to each connecting rod 508 to pivot therewith about the axes of the support shafts 506. The driving rod 510 extends through an opening 512 (FIGS. 22, 23) defined on each longitudinal side of the outer body 478. Each driving rod 510 is received by the head and foot lower siderail members 340, 342 to cause their rotation about the pivot axis A (FIG. 15) when raising and lowering the siderail 302. More specifically, each driving rod 510 is received in the corresponding opening 370 (one of which is shown in FIG. 15) of the head and foot lower siderail members 340, 342 so that, when the linkage assembly 350 is displaced between the deployed and stowed positions, the driving rods 510 cause the lower siderail body 310 to pivot about the pivot axis A. The driving rods 510 thus guide the movement of the lower siderail members 340, 342. As shown in FIG. 23, the openings 512 defined by the outer body 478 are appropriately shaped to allow the full range of rotation of the driving rods 510 about the axis of the support shafts 506 between the deployed and stowed positions of the siderail 302.

It is contemplated that, in other embodiments, the support shafts 506, connecting rods 508 and driving rods 510 may be omitted. In such embodiments, the lower siderail members 340, 342 may be fixed to the upper crank link 404 to move together therewith. For example, the lower siderail members 340, 342 may instead receive respective fasteners that traverse the upper crank link 404 to connect the lower siderail members 340, 342 thereto.

Returning to FIG. 24, the damper 450 is connected to the link frame 484. In particular, a fixed end 457 of the damper 450 is connected to a damper mount 514 of the link frame 484 disposed near the upper end 491 of the link frame 484. As described above, the moving end 451 of the damper 450 is connected to the lower crank link 402. As such, during the descent of the siderail 302 from the deployed position to the stowed position, the damper 450 is compressed, thereby damping the movement of the siderail 302. This can provide a more controlled displacement of the siderail 302. During the ascent of the siderail 302 from the stowed position to the deployed position, the damper 450 is extended and does not offer resistance to the movement of the siderail 302. As shown in FIG. 22, the damper 450 is partly contained within the interior cavity defined by the outer body 478 of the intermediate link 406. The piston rod 453 of the damper 450 extends out of the outer body 478 through an opening 516 defined by the inner casing 482. Thus, as can be seen in FIGS. 2, 4, 6 and 9, the damper 450 is concealed from view from the lateral outer side of the siderail 302 throughout the range of motion of the siderail 302. Moreover, from the lateral inner side of the siderail 302, a majority of the damper 450 is also concealed from view throughout the range of motion of the siderail 302.

As mentioned above, the upper connecting link 408 is pivotably connected to the intermediate link 406 via the bushings 494. In particular, with reference to FIG. 17, the bushings 494 are received by two lower arms 520 of the upper connecting link 408. At an opposite end of the upper connecting link 408, two shafts 522 are provided extending longitudinally and coaxial with each other. The shafts 522 are connected to the upper siderail body 308, namely to an internal supporting structure (not shown) of the upper siderail body 308, to form the upper body joint 429. As such, the shafts 522 define the pivot axis of the upper body joint 429.

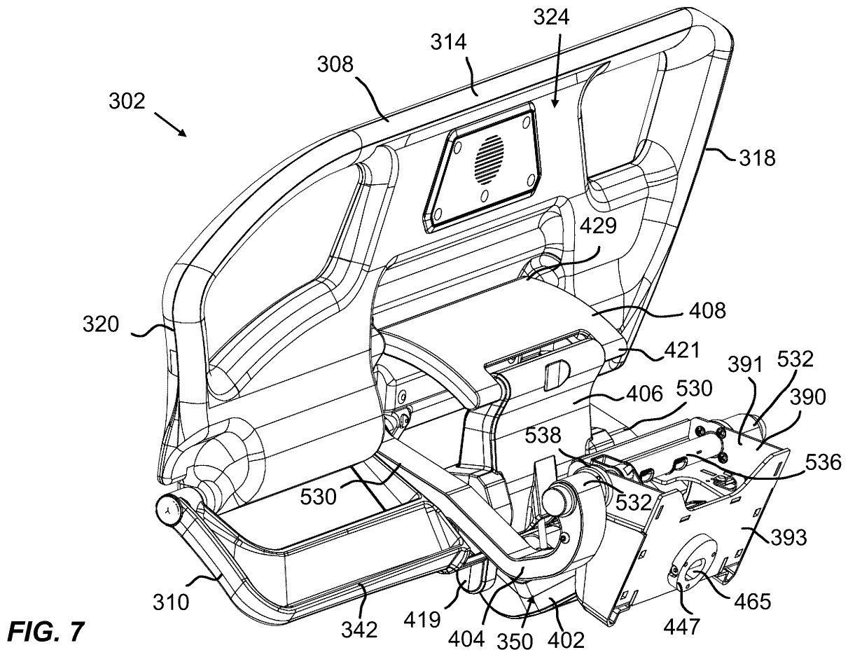

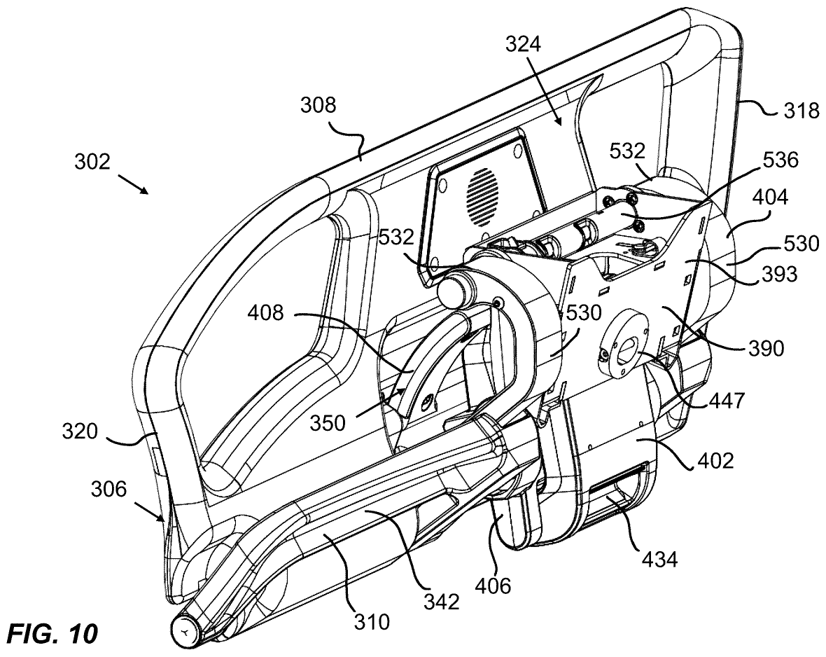

Returning to FIG. 16, in this embodiment, the upper crank link 404 includes two link arms 530 that are spaced from each other in the longitudinal direction of the siderail 302. In particular, each link arm 530 is disposed longitudinally outward of the intermediate link 406 such that the intermediate link 406 is disposed longitudinally between both link arms 530. In the stowed position, each link arm 530 is received in the corresponding recess 368 (FIG. 15) of the head and foot lower siderail members 340, 342. However, in this embodiment, the link arms 530 are not fixed to the lower siderail members 340, 342 and are movable relative thereto. In other embodiments, the link arms 530 are fixed to the lower siderail members 340, 342 so that they move together and there is no relative movement therebetween. In this embodiment, the link arms 530 are identical to each other and thus only one of the link arms 530 will be described herein. As shown in FIG. 16, the link arm 530 extends from a proximal end 532 to a distal end 534. In this embodiment, the link arm 530 is generally J-shaped. However, the link arm 530 could have a linear shape or any other suitable shape in other embodiments. As best shown in FIGS. 7 and 10, a pivot shaft 536 extends through the proximal end 532 of each link arm 530 and is pivotably connected to the frame connector 390 by bearings 538 (one of which is shown in FIG. 16) connected to the sidewalls 391 of the frame connector 390. The pivot shaft 536 thus defines the pivot axis of the upper frame joint 412.

As shown in FIG. 16, the distal end 534 of the link arm 530 defines a round opening 540 that is configured to receive a respective shaft (not shown) that defines the pivot axis of the lower body joint 431. The distal end 534 of the link arm 530 thus pivots about the shaft. As mentioned above, the lower body joint 431 shares the common pivot axis A about which the lower siderail body 310 pivots relative to the upper siderail body 308. In this embodiment, part of the proximal ends 344, 358 (FIG. 15) of the head and foot lower siderail members 340, 342 wrap around the distal ends 534 of the corresponding link arms 530.

In some embodiments, the link arms 530 may not be received in the recesses 368 of the lower siderail members 340, 342. For instance, in some embodiments, the recesses 368 may be omitted from the lower siderail members 340, 342. In such cases, for example,

While the upper crank link 404 has two link arms 530 in this embodiment, it is contemplated that a single link arm 530 could be provided in other embodiments. The dimensions of the single link arm 530 would be chosen to adequately support the loads to which it is subjected.

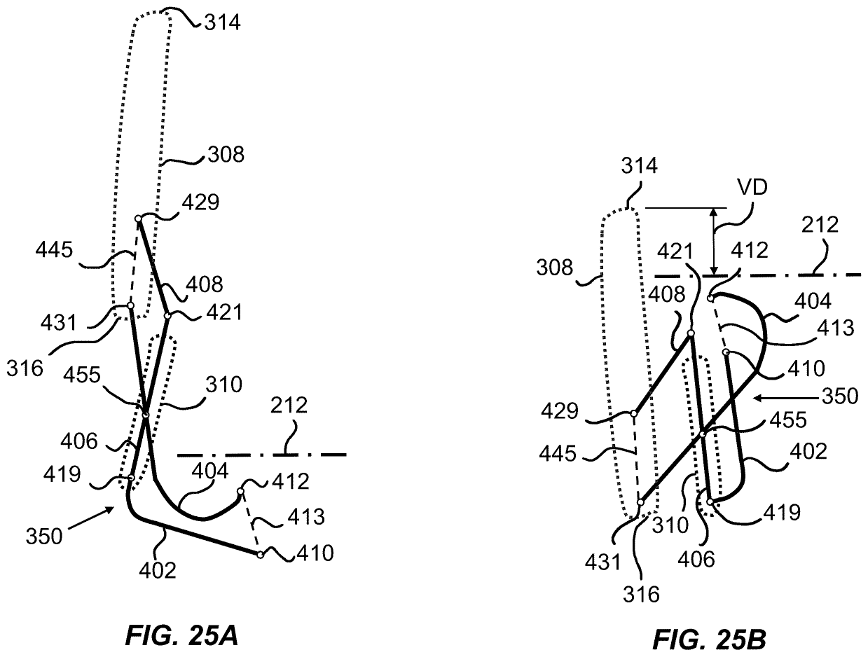

With reference to the schematic representations shown in FIGS. 25A and 25B, a different configuration of the siderail 302 is also contemplated. In this alternative embodiment, the lower siderail body 310 is not pivotably connected to the upper siderail body 308. Instead, the lower siderail body 310 is fixed to the intermediate link 406 in order to move together therewith. In other words, the lower siderail body 310 is independent (i.e., disconnected) from the upper siderail body 308. For instance, the upper and lower siderail bodies 308, 310 do not share a common pivot axis about which they both pivot. As can be seen in FIG. 25A, in the deployed position, the lower siderail body 310 is disposed below the upper siderail body 308 so that the siderail 302 has the deployed height DH. The lower siderail body 310 follows the motion of the intermediate link 406 as the siderail 302 moves towards the stowed position. Notably, as shown in FIG. 25B, in the stowed position, the lower siderail body 310 is disposed laterally inwardly of the upper siderail body 308 so that the siderail 302 has the stowed height SH, corresponding to the height of the upper siderail body 308. In this alternative embodiment, the position of the intermediate link 406, along with the lower crank link 402 and the upper connecting link 408, would be interchanged with the position of the upper crank link 404. More specifically, the upper crank link 404 would take up the central position of the links 402, 406, 408 in the longitudinal direction of the siderail 302 (thus only a single link arm 530 could be provided), and the assembly of the links 402, 406, 408 would be doubled so that an identical assembly of the links 402, 406, 408 would be disposed on either longitudinal side of the upper crank link 404. In this manner, the head and foot lower siderail members 340, 342 would each be connected to a corresponding one of the intermediate links 406. As will be appreciated, the latch system 432 could be configured differently, such as for example being integrated into the upper crank link 404. This alternative embodiment thus provides a similar functionality as the previously-described embodiment, as the siderail 302 still collapses to a more compact configuration in the stowed position.

As mentioned above, the foot siderails 304 function in the same manner as the head siderails 302 and thus their functionality as it relates to their motion between the deployed and stowed positions is the same.

The embodiments described above are intended to be exemplary only. The scope of the invention is therefore intended to be limited solely by the appended claims.

1. A siderail for a patient support apparatus, comprising:
an upper siderail body;
a lower siderail body;
a linkage assembly operatively connected to the upper and lower siderail bodies and configured to guide movement of the siderail between a deployed position and a stowed position,
in the deployed position, the upper siderail body being disposed above the lower siderail body so that the siderail has a deployed height defined between an upper end of the upper siderail body and a lower end of the lower siderail body,
in the stowed position, the lower siderail body being disposed at least partly laterally inwardly of the upper siderail body so that the siderail has a stowed height defined between the upper end of the upper siderail body and a lower end of the upper siderail body,
the deployed height being greater than the stowed height,
the linkage assembly comprising:
a first link pivotably connected to a frame connector at a first frame joint;
a second link pivotably connected to the first link at a first connecting joint;
a third link pivotably connected to the second link at a second connecting joint disposed vertically higher than the first connecting joint and pivotably connected to the upper siderail body at a first body joint; and
a fourth link pivotably connected to the frame connector at a second frame joint, the fourth link being pivotably connected to the upper siderail body at a second body joint,
the second link and the fourth link being ternary links that are connected to each other at an intermediate joint,
the intermediate joint being disposed, along the second link, between the first connecting joint and the second connecting joint,
the intermediate joint being disposed, along the fourth link, between the second frame joint and the second body joint.

2. The siderail of claim 1, wherein the first body joint is disposed vertically higher than the second body joint.

3. The siderail of claim 1, wherein the second body joint is disposed generally along the lower end of the upper siderail body.

4. The siderail of claim 1, wherein, in the stowed position, the first body joint is disposed vertically lower than the second connecting joint.

5. The siderail of claim 1, wherein, in the stowed position, the first, second and third links overlap each other in a vertical direction.

6. The siderail of claim 1, wherein the first frame joint is disposed vertically lower than the second frame joint.

7. The siderail of claim 1, wherein, in the stowed position, the second link extends generally parallel to the upper siderail body and is disposed laterally inwardly of the upper siderail body.

8. The siderail of claim 1, wherein the lower siderail body is pivotably connected to the upper siderail body.

9. The siderail of claim 8, wherein the second body joint is coaxial with a pivot defined between the lower siderail body and the upper siderail body.

10. The siderail of claim 1, wherein:
the fourth link includes a first arm and a second arm spaced from the first arm in a longitudinal direction of the siderail; and
the second link is disposed longitudinally between the first and second arms.

11. The siderail of claim 1, wherein:
the lower siderail body includes a first lower siderail member and a second lower siderail member spaced from the first lower siderail member in a longitudinal direction of the siderail; and
each of the first and second lower siderail members is connected to the second link so that movement of the first and second lower siderail members is guided by the second link.

12. The siderail of claim 1, wherein the lower siderail body is fixed to the second link to move together therewith between the deployed and stowed positions.

13. The siderail of claim 1, wherein:
the upper siderail body has a lateral outer surface configured to face away from the patient support apparatus;
a maximum lateral distance between the lateral outer surface of the upper siderail body and a pivot axis of the second frame joint is attained at a given intermediate position of the siderail between the deployed and stowed positions; and
the maximum lateral distance is less than 10 inches.

14. The siderail of claim 1, wherein:
the upper siderail body has a lateral outer surface configured to face away from the patient support apparatus;
a maximum lateral distance between the lateral outer surface of the upper siderail body and a pivot axis of the second frame joint is attained at a given intermediate position of the siderail between the deployed and stowed positions; and
a displacement of the lateral outer surface in a lateral direction between the deployed position and the given intermediate position is less than 5 inches.

15. The siderail of claim 1, wherein the siderail includes a damper for damping a descent of the siderail from the deployed position to the stowed position, at least a majority of the damper remaining concealed throughout a motion of the siderail between the deployed and stowed positions.

16. The siderail of claim 15, wherein:
the damper is connected between the first link and the second link; and
the second link comprises an internal cavity, at least a majority of the damper being disposed within the internal cavity.

17. The siderail of claim 1, wherein the linkage assembly forms a six-bar linkage.

18. A patient support apparatus comprising:
a base;
an upper frame operatively connected to the base;
a deck for supporting a patient; and
the siderail of claim 1 disposed along a periphery of the deck.

19. The patient support apparatus of claim 18, wherein:
the deck includes an upper body deck section that can be selectively raised and lowered relative to the upper frame to adjust an angle of the upper body of the patient relative to a lower body of the patient; and
the siderail is mounted to the upper body deck section so as to move together therewith.

20. The patient support apparatus of claim 18, wherein, in the stowed position, a vertical distance between the upper end of the upper siderail body and a top face of the deck when the deck is in a flat horizontal position is less than 3 inches.

21. The patient support apparatus of claim 18, wherein, in the stowed position, the upper siderail body extends laterally inwardly from the upper end to the lower end thereof.

22. A siderail for a patient support apparatus, comprising:
an upper siderail body;
a lower siderail body;
a linkage assembly operatively connected to the upper and lower siderail bodies and configured to guide movement of the siderail between a deployed position and a stowed position,
in the deployed position, the upper siderail body being disposed above the lower siderail body so that the siderail has a deployed height defined between an upper end of the upper siderail body and a lower end of the lower siderail body,
in the stowed position, the lower siderail body being disposed at least partly behind the upper siderail body so that the siderail has a stowed height defined between the upper end of the upper siderail body and a lower end of the upper siderail body,
the deployed height being greater than the stowed height,
the linkage assembly forming a six-bar linkage.

23. A siderail for a patient support apparatus, comprising:
an upper siderail body;
a lower siderail body;
a linkage assembly operatively connected to the upper and lower siderail bodies and configured to guide movement of the siderail between a deployed position and a stowed position,
in the deployed position, the upper siderail body being disposed above the lower siderail body so that the siderail has a deployed height defined between an upper end of the upper siderail body and a lower end of the lower siderail body,
in the stowed position, the lower siderail body being disposed at least partly behind the upper siderail body so that the siderail has a stowed height defined between the upper end of the upper siderail body and a lower end of the upper siderail body,
the deployed height being greater than the stowed height,
the lower siderail body being independent from the upper siderail body.
